(19) United States
(12) Patent Application Publication
(10) Pub. No.: US 2007/0238450 A1
(43) Pub. Date: Oct. 11, 2007

(54) SOFTWARE ACTIVATION IN A MOBILE TERMINAL

(76) Inventor: Lena Hogberg, Stockholm (SE)

Correspondence Address: HARRITY SNYDER, L.L.P., 11350 RANDOM HILLS ROAD, SUITE 600, FAIRFAX, VA, 22030, US

(21) Appl. No.: 11/279,049

(22) Filed: Apr. 7, 2006

(51) Int. Cl. H04M 3/00

(52) U.S. Cl. 455/418; 455/466

(57) ABSTRACT

An activation and reporting mechanism for software in a mobile terminal allows the software to be activated by an end-user. In one implementation, a mobile terminal receives an indication that an end-user of the mobile terminal is attempting to use the software and gathers registration information from the end-user. The mobile terminal transmits the registration information and then activates the software.

### TECHNICAL FIELD OF THE INVENTION

The invention relates generally to software activation and, more particularly, to software activation in a mobile terminal.

### DESCRIPTION OF RELATED ART

Communication devices, such as mobile telephones, have become increasingly versatile. For example, mobile telephones often include software applications or programs that enable users to access their email accounts, play music and games, or perform other functions, such as obtain directions to a place of interest, obtain sports scores, or obtain weather related information. Such applications have made communication devices increasingly important to users.

Frequently, these applications may either be installed by the manufacturer of the mobile telephone or, in some situations, be downloaded by the end-user to the mobile telephone. The creator of these applications may desire some degree of control of the applications. For example, in the situation in which mobile telephone is manufactured to include the application (i.e., loaded on the mobile telephone prior to sale), the application creator may wish to know how many copies of the application have been activated by the end-users of the mobile telephone.

### SUMMARY

According to one aspect, a mobile terminal includes a memory including a software application for use at the mobile terminal and logic. The logic is configured to receive an indication that an end-user of the mobile terminal is attempting to use the software application. The logic is further configured to activate the software application for use by the end-user.

Additionally, the registration information includes an identification of the software application being activated and is used to count the number of activations relating to the software application.

Additionally, the logic may be further configured to gather the registration information from the end-user;

Additionally, the registration entity may include one or more of a manufacturer of the mobile terminal, an application provider that authored the software, or a service provider for the mobile terminal.

Additionally, the registration information may include one or more of a name, address, or a telephone number of the mobile terminal.

Additionally, the registration information may include a unique identification number of the mobile terminal or an account number of the user associated with the mobile terminal.

Additionally, the registration information includes payment information for the software application.

Additionally, transmitting the registration information includes transmitting the registration information as an email message or an SMS message.

Additionally, the logic of the mobile terminal receives a license key at the mobile terminal in response to the transmitting the registration information. The activation of the software application for use by the end-user is performed using the license key to activate the software.

Additionally, wherein the software application is stored in the memory of the mobile terminal. The software application may also be downloaded to the memory of the mobile terminal.

In another aspect, a method is disclosed. The method is for activating software in a mobile terminal. The method includes receiving an indication that an end-user of the mobile terminal is attempting to use the software; gathering information from the end-user for registering the software; transmitting the registration information using the mobile terminal to one or more of a manufacturer of the mobile terminal, an application provider associated with the software, or a service provider for the mobile terminal; and activating the software for use by the end-user.

Additionally, the registration information may include one or more of a name, address, or a telephone number of the mobile terminal.

Additionally, the registration information may include a unique identification number of the mobile terminal or an account number of the user associated with the mobile terminal.

The registration information may also include payment information for the software.

Additionally, transmitting the registration information includes transmitting the registration information as an email message or an SMS message.

Additionally, the method includes receiving a license key at the mobile terminal in response to the transmitting of the registration information.

Additionally, activating the software for use by the end-user is performed using the license key to activate the software.

In another aspect, a method of activating software in a mobile terminal is disclosed. The method includes determining location information or language preference information for an end-user of the mobile terminal; selecting a software license agreement based on the determined information; presenting the selected software license agreement to the end-user; and activating the software when the end-user accepts the presented software license agreement.

Additionally, the location information is determined in response to the end-user attempting to use the software.

Additionally, the determined location information includes at least one of a city, zip code, or country of residence.

Additionally, the method further includes receiving an indication from the end-user relating to whether the end-user accepts the software license agreement; and transmitting the indication to one or more of a manufacturer of the mobile terminal, an application provider that authored the software, or a service provider for the mobile terminal.

Additionally, the software is pre-stored in the mobile terminal.

Additionally, the software is downloaded to the mobile terminal by an end-user.

In another aspect, a device includes means for determining location information for an end-user of a mobile terminal; means for selecting a software license agreement based on the location information; means for presenting the selected software license agreement to an end-user of the device; and means for activating the software when the end-user accepts the presented software license agreement.

In yet another aspect, a mobile device is provided. The mobile device includes a memory storing a software application that requires activation before an end-user is provided with full use privileges for the software application, the activation being performed via an activation process performed using an interface specified by a designer of the software application using an application programming interface (API) provided by a manufacturer of the mobile terminal. The mobile device further includes logic configured to provide wireless communication to an end-user of the mobile device, the activation process including communicating with a registration entity via the logic.

Additionally, the registration entity includes one or more of a manufacturer of the mobile terminal, an application provider that authored the software application, or a service provider for the mobile terminal.

Additionally, the communication during the activation process includes an email message or an SMS message.

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems consistent with the invention may be implemented;

FIG. 2 is a diagram of an exemplary mobile terminal according to an implementation consistent with the invention;

FIG. 3 is a diagram conceptually illustrating a relationship of parties involved in an exemplary distribution and use of a mobile terminal;

FIG. 4 is a flow chart illustrating an exemplary process consistent with aspects of the invention;

FIG. 5 is a diagram conceptually illustrating portions of the acts shown in FIG. 4;

FIG. 6 is a diagram illustrating an exemplary interface of a “push” email application displayed in a display area of a mobile terminal;

FIG. 7 is a flow chart illustrating exemplary operations that may be performed in the context of accepting a licensing agreement;

FIG. 8 is a flow chart illustrating another implementation of exemplary operations that may be performed in the context of a user accepting a licensing agreement for a software application at a mobile terminal; and

FIG. 9 is a flow chart illustrating another implementation of exemplary operations that may be performed in the context of a user accepting a licensing agreement for a software application at a mobile terminal.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

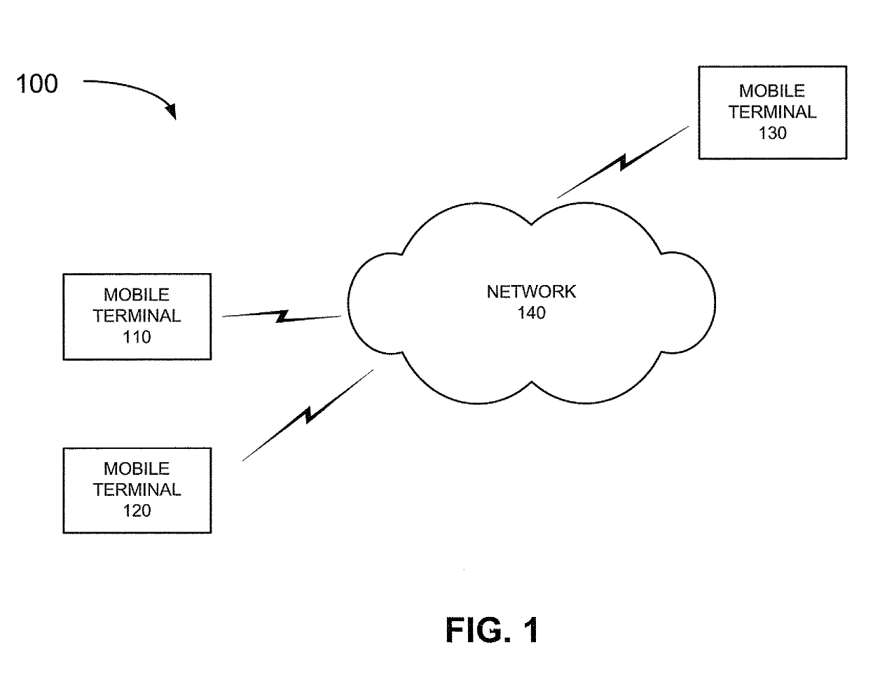

FIG. 1 is a diagram of an exemplary system 100 in which methods and systems consistent with the invention may be implemented. System 100 may include mobile terminals 110, 120 and 130 connected via network 140. Only three mobile terminals are shown for simplicity. It should be understood that system 100 may include other numbers of mobile terminals.

The invention is described herein in the context of a mobile terminal. As used herein, the term “mobile terminal” may include a cellular radiotelephone with or without a multi-line display; a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; and a conventional laptop and/or palmtop receiver or other appliance that includes a radiotelephone transceiver.

Network 140 may include one or more networks including a cellular network, a satellite network, the Internet, a telephone network, such as the Public Switched Telephone Network (PSTN), a metropolitan area network (MAN), a wide area network (WAN), a local area network (LAN) or another type of network. Mobile terminals 110, 120 and 130 may communicate with each other over network 140 via wired, wireless or optical connections.

In an exemplary implementation, network 140 includes a cellular network that uses components for transmitting data to and from mobile terminals 110, 120 and 130. Such components may include base station antennas (not shown) that transmit and receive data from mobile terminals within their vicinity. Such components may also include base stations (not shown) that connect to the base station antennas and communicate with other devices, such as switches and routers (not shown) in accordance with known techniques.

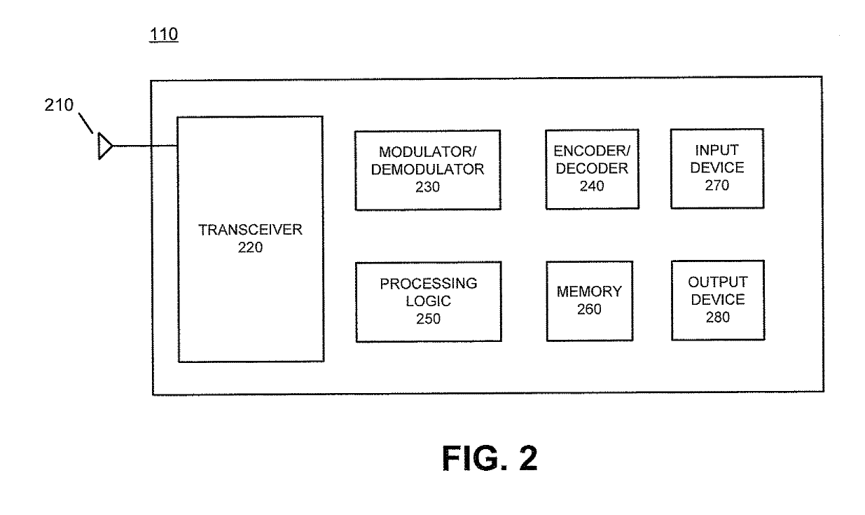

FIG. 2 is a diagram of mobile terminal 110 according to an exemplary implementation consistent with the invention. It should be understood that mobile terminals 120 and 130 may include the same or similar elements and may be configured in the same or in a similar manner.

Mobile terminal 110 may include one or more radio frequency (RF) antennas 210, transceiver 220, modulator/demodulator 230, encoder/decoder 240, processing logic 250, memory 260, input device 270 and output device 280. These components may be connected via one or more buses (not shown). In addition, mobile terminal 110 may include one or more power supplies (not shown). One skilled in the art would recognize that the mobile terminal 110 may be configured in a number of other ways and may include other or different elements.

RF antenna 210 may include one or more antennas capable of transmitting and receiving RF signals. In one implementation, RF antenna 210 may include one or more directional and/or omni-directional antennas. Transceiver 220 may include components for transmitting and receiving information via RF antenna 210. In an alternative implementation, transceiver 220 may take the form of separate transmitter and receiver components, instead of being implemented as a single component. Modulator/demodulator 230 may include components that combine data signals with carrier signals and extract data signals from carrier signals. Modulator/demodulator 230 may include components that convert analog signals to digital signals, and vice versa, for communicating with other devices in mobile terminal 110.

Encoder/decoder 240 may include circuitry for encoding a digital input to be transmitted and for decoding a received encoded input. Processing logic 250 may include a processor, microprocessor, an application specific integrated circuit (ASIC), field programmable gate array (FPGA) or the like. Processing logic 250 may execute software programs or data structures to control operation of mobile terminal 110. Memory 260 may include a random access memory (RAM) or another type of dynamic storage device that stores information and instructions for execution by processing logic 250; a read only memory (ROM) or another type of static storage device that stores static information and instructions for use by processing logic 250; and/or some other type of magnetic or optical recording medium and its corresponding drive. Instructions used by processing logic 250 may also, or alternatively, be stored in another type of computer-readable medium accessible by processing logic 250. A computer-readable medium may include one or more memory devices and/or carrier waves.

Input device 270 may include any mechanism that permits an operator to input information to mobile terminal 110, such as a microphone, a keyboard, a keypad, a mouse, a pen, voice recognition and/or biometric mechanisms, etc. Output device 280 may include any mechanism that outputs information to the operator, including a display, a speaker, a printer, etc. Output device 280 may also include a vibrator mechanism that causes mobile terminal 110 to vibrate.

Mobile terminal 110, consistent with the invention, may perform processing associated with, for example, operation of the core features of mobile terminal 110 or operation of additional applications associated with mobile terminal 110, such as software applications provided by third party software providers. Mobile terminal 110 may perform these operations in response to processing logic 250 executing sequences of instructions contained in a computer-readable medium, such as memory 260. It should be understood that a computer-readable medium may include one or more memory devices and/or carrier waves. Execution of sequences of instructions contained in memory 260 causes processing logic 250 to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

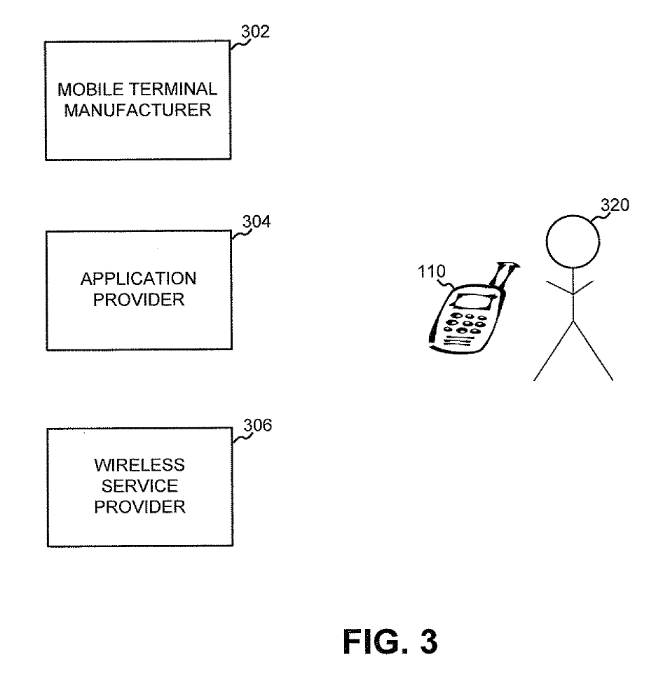

FIG. 3 is a diagram conceptually illustrating an exemplary relationship of parties involved in distribution and use of mobile terminal 110. A mobile terminal manufacturer 302 of mobile terminal 110 may design and/or manufacturer the mobile terminal for sale to end-users 320. Mobile terminal manufacturer 302 may market mobile terminal 110 either directly or through resellers to end-users 320. Mobile terminal manufacturer 302 may pre-install software applications on mobile terminals 110, such as applications produced by mobile terminal manufacturer 302 or applications created by another party, such as application provider 304. Examples of such applications include email applications, games, or any other applications that end-users 320 may wish to use with mobile terminals 110.

Wireless service provider 306 may provide wireless communication services to mobile terminal 110 and to end-user 320. To this end, wireless service provider 306 may operate a network of wireless and wired devices designed to provide connectivity to mobile terminal 110. In some situations, wireless service provider 306 may not necessarily own or operate its own network. For example, a category of mobile network operators that is emerging in some markets is the so-called Mobile Virtual Network Operator (MVNO). MVNOs typically lease a physical network from another wireless service provider.

Application provider 304 may be a third party that designs software applications for mobile terminals 110. Although shown as a single element in FIG. 3, application provider 304 may include a number of different entities that create applications for mobile terminal 110. Mobile terminal manufacturer 302 and application provider 304 may, for example, agree to distribute mobile terminals that include a software application created by application provider 304 for which mobile terminal manufacturer 302 agrees to pay application provider 304 based on the number of end-users that activate the application.

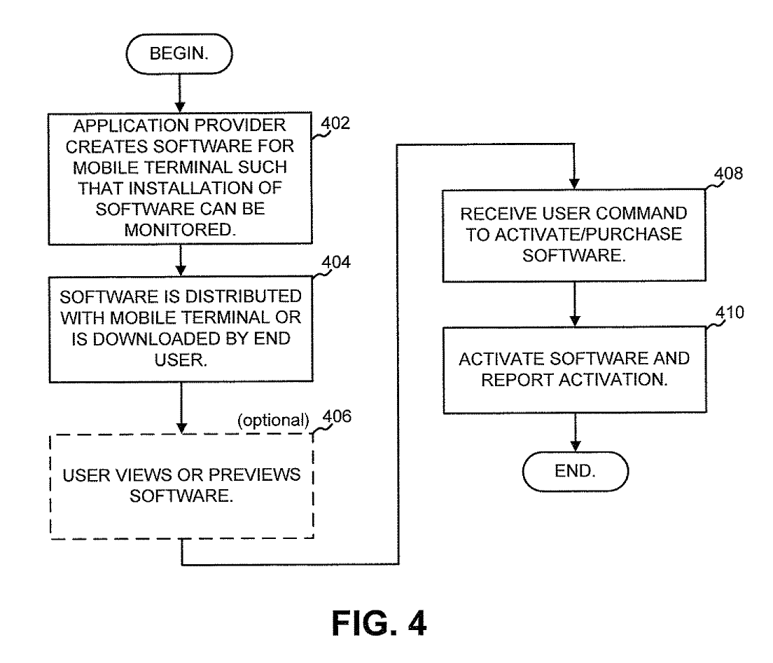

FIG. 4 is a flow chart illustrating an exemplary process consistent with aspects of the invention. Application provider 304 may create software for mobile terminals (act 402). The application provider may create the software with a desire to in some way track or monitor the installation and/or use of the software by the end-users (act 402). For example, application provider 304 may require all end-users 320 to agree to a license agreement, such as an End User License Agreement (EULA), before using the application for the first time. As another example, application provider 304 may desire to know how many end-users 320 decide to activate their applications.

The software created by application provider 304 may be distributed to end-users 320 (act 404). The software may, for example, be distributed with the mobile terminals via a partnership with mobile terminal manufacturer 302 or downloaded and installed on demand by the end-users (act 404).

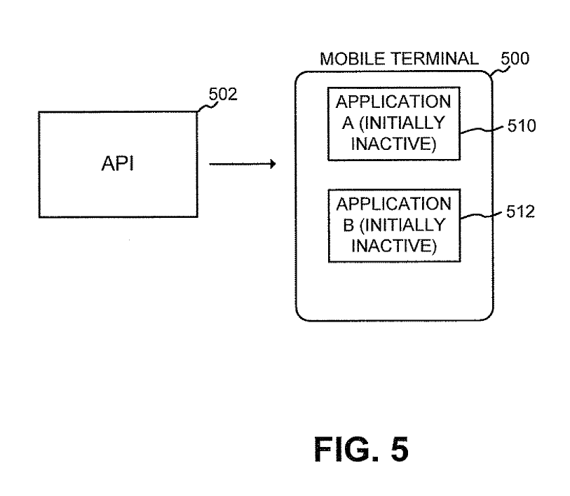

FIG. 5 is a diagram conceptually illustrating acts 402 and 404. Application programming interface (API) 502 may include one or more software tools provided by mobile terminal manufacturer 302 that assist application provider 304 in tracking or monitoring their created software. API 502 may be provided by mobile terminal manufacturer 302 and may generally be customized for one or more mobile terminals, such as the mobile terminals offered by mobile terminal manufacturer 302. The API may display a menu via output device 280 (FIG. 2), such as a display screen of mobile terminal 110. The menu may provide functionality/selections to facilitate activation of the application beyond users 320. Through API 502, application provider 304 may be able to provide activation and reporting functionality for the applications that they create.

As shown in FIG. 5, assume that application provider 304, with the assistance of API 502, has created two applications that are to be installed on a number of mobile terminals 500 manufactured by mobile terminal manufacturer 302. The applications, labeled as application A 510 and application B 512 may be initially inactive on the mobile terminal 500. Application A 510 and B 512 may each be associated with identification information that identifies the particular application. The end-user of the mobile terminal 500 may activate each application when desired (or not at all).

Assume that end-user 320 is interested in application A 510. In some implementations, application A 510 may be designed such that the end-user can initially view or preview the software before actually registering or activating it (act 406). For example, assume that application A 510 is a “push” email solution. That is, application A 510 may include software that periodically downloads, over network 140, email messages sent to the user, whenever mobile terminal 500 is turned on. The user may then view the downloaded messages on-demand, and potentially also respond via one or more new messages.

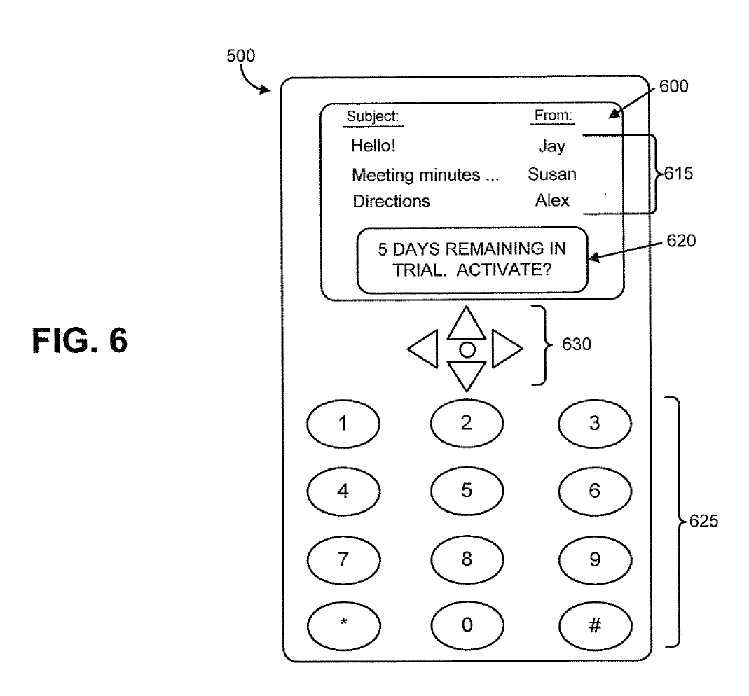

FIG. 6 is a diagram illustrating an exemplary interface 600 of a “push” email application A 510 displayed in a display area of a mobile terminal 500. As shown, interface 600 displays an interface for a preview or trial version of the application. Interface 600 includes an email status section 615 in which a list of email messages are presented to the user, including the “Subject” and “From” fields of each of a number of emails received by mobile terminal 500. The end-user may, for example, select one of the emails using arrow buttons 630, at which point the user may view the contents of the message and/or respond to the message.

Interface 600 may be a preview version of the “push” email application, and as such, may include an activation graphical selection button 620. The preview version of the application may, for example, be limited in its functionality or limited to being used for only a specified time limit. This may help the user determine whether he/she would like to activate the application.

Referring back to FIG. 4, when the user decides to accept, activate, or purchase an application, such as application 510 or 512, the user may correspondingly indicate his/her preference (act 408). In the example of FIG. 6, the user may select button 620 to indicate that they would like to activate the “push” email software.

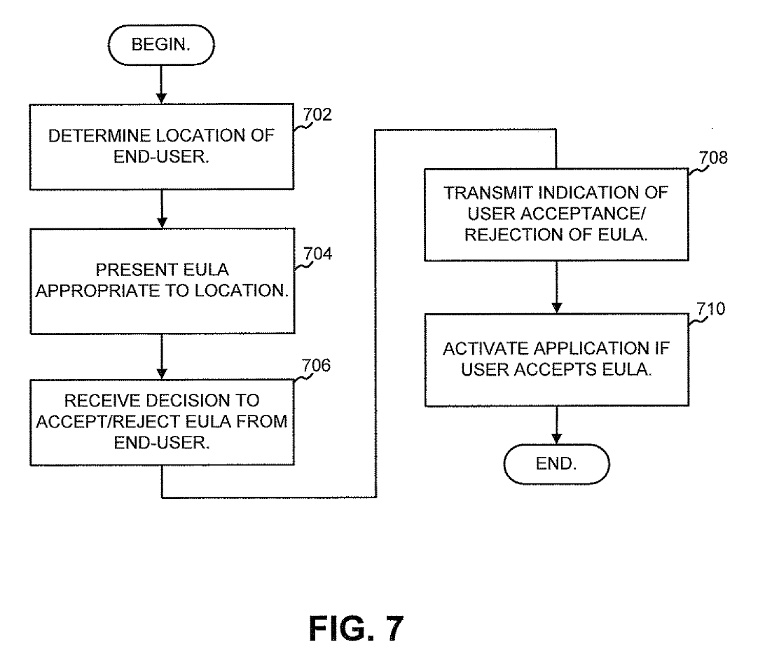

In response to the user's selection in act 408, the application may communicate with one or more of mobile terminal manufacturer 302, application provider 304, or wireless service provider 306 to, for example, activate or register the application (act 410). The activation/registration performed in act 410, can take a number of forms. For example, the activation/registration may provide for the acceptance of a license agreement, may allow application provider 304 to count the number of users actually using their applications without providing any other information about the mobile terminal or the user, or may provide for a more advanced registration process in which a license key is received by mobile terminal 500. Examples of act 410 consistent with aspects of the invention are described in more detail below with reference to FIGS. 7-9.

FIG. 7 is a flow chart illustrating exemplary operations that may be performed in act 410 in the context of accepting a licensing agreement, such as an EULA, which is a license that specifies the parameters of the permission granted by the owner of the application to the end-user. The specific language of an EULA may vary based on, for example, the legal jurisdiction, such as the country of residence of the end-user.

The process of FIG. 7 may begin by determining location information for the end-user, such as the country of residence or legal jurisdiction of the end-user of the mobile terminal (act 702). This may be performed by, for example, querying the user for the user's jurisdiction of residence, based on, for example, the user's country, city, zip code, or other location information. In one implementation, a list of countries may be presented to the user and the user may be asked to select the country of which the user is a resident. In mobile terminals that include mobile browser applications, this information can be displayed within the browser of the mobile terminal. In other implementations, the country of residence of the end-user may be obtained automatically by the mobile terminal, such as by obtaining the information from wireless service provider 306.

Based on the location information received in act 702, the mobile terminal may select and present the legally correct EULA to the user (act 704). For example, the mobile terminal may store a separate EULA for each possible country and present the EULA appropriate for the country for to the user. Additionally, the mobile terminal may present the EULA to the user in the language that is preferred by the user. For example, if the user has previously indicated a language preference, such as when first activating a phone, the EULA may be presented in that language.

The user may accept or reject the displayed EULA by, for example, pressing an appropriate key on the mobile terminal (act 706). The users decision may be transmitted to one or more of mobile terminal manufacturer 302, application provider 304, or wireless service provider 306 (also referred to as a registration entity herein) (act 708). In some implementations, the end-users decision may only be transmitted when the user accepts the EULA. In this manner, the number of users that accept the EULA and are therefore permitted to use the application may be reported (e.g., counted or tracked) by one or more of mobile terminal manufacturer 302, application provider 304, or wireless service provider 306. This may allow an entity that owns or controls the software application to obtain statistics associated with the software application and may allow the provider to make changes/additions to the software based on use of the software application. The user's decision may be transmitted as, for example, an email message or a text message using the well known Short Message Service (SMS) protocol. If the user has accepted the EULA, the mobile terminal may activate the application (act 710).

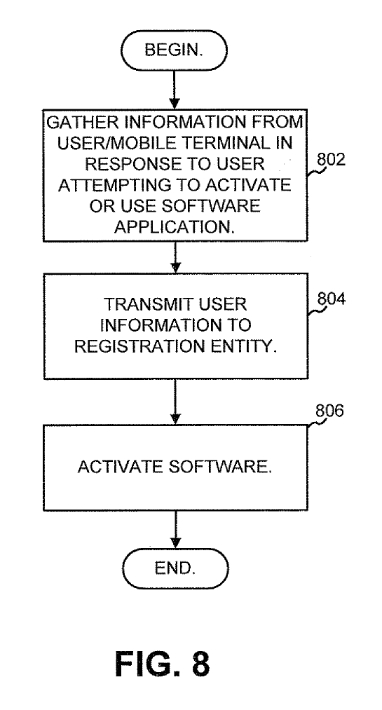

FIG. 8 is a flow chart illustrating a second implementation of exemplary operations that may be performed in the context of a user accepting a licensing agreement for a software application at a mobile terminal 110. The process of FIG. 8 may begin when the end-user attempts to activate or use the software application, and may include gathering information from the user and/or from the mobile terminal of the end-user (act 802). The information may include information that will be used to register the application that is to be activated, and may include one or more of, the name, address, other personal information of the user, the telephone number of the mobile terminal, a unique identification number of the mobile terminal, or information relating to an account of the user. For example, regarding account information, it is common in GSM mobile terminals to include a removable card that stores information relating to an account of the user, such as account information relating to the user's account with a wireless provider. If the user acquires a new mobile terminal, the user can simply move the card to the new mobile terminal to identify the user (and the new mobile terminal) to the wireless service provider. In some situations, if the software requires the user to pay a fee to use the software, the information may also include payment information entered by the user, such as credit card information or an account that is to be charged. Some of this information, such as the mobile telephone number, an identification number of the mobile terminal, and the identification information from the removable chip, may be automatically gathered from the mobile terminal, while personal information from the user may be gathered by prompting the user to enter the information.

The information gathered in act 802 may be transmitted to the registration entity (i.e., one or more of mobile terminal manufacturer 302, application provider 304, or wireless service provider 306) (act 804). This information may be transmitted as, for example, an email message or a text message using SMS. The mobile terminal may then activate the software application (act 806), allowing the user full use of the application. In some implementations, the software application may be automatically activated when the user first begins to use it, the message sent to the registration entity may simply identify the software application that is being activated. This allows the registration entity to count the number of activated software applications.

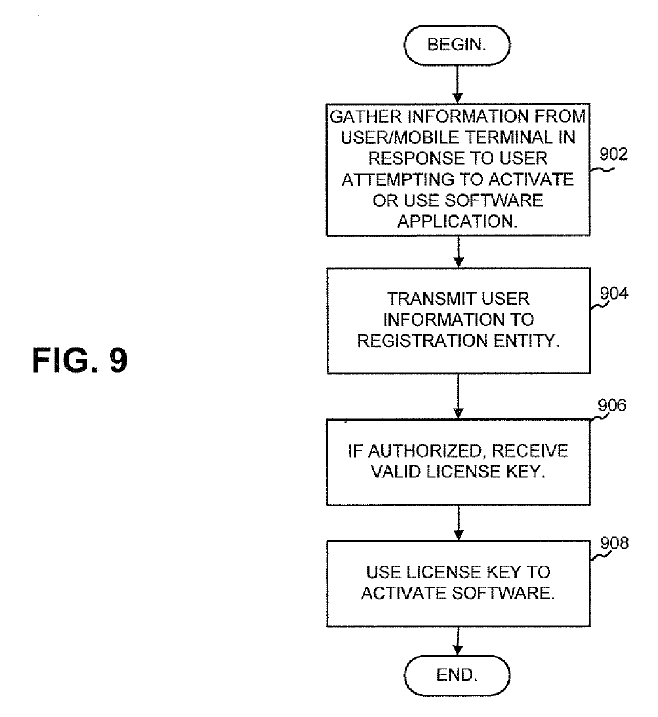

FIG. 9 is a flow chart illustrating another implementation of exemplary operations that may be performed in the context of a user accepting a licensing agreement at a mobile terminal. The process of FIG. 9 may begin by gathering information from the user and/or from the mobile terminal of the end-user (act 902). Similar to the information gathered in act 802, the information may include information that will be used to register the application that is to be activated, and may include one or more of, the name of the user, the address of the user, other personal information of the user, the telephone number of the mobile terminal 500, a unique identification number of the mobile terminal 500, or information relating to an account of the user. The information gathered in act 902 may be transmitted to a registration entity (act 904). Additionally, the registration entity may be sent information identifying the application that is being registered. This information may be transmitted as, for example, an email message or a text message using SMS. In response to transmitting the information, the mobile terminal may receive licensing information, such as a software license key (act 906). The licensing information may be generated by and then transferred from the registration entity to mobile terminal 500. The mobile terminal may verify the licensing information and use it to activate the software application (act 908), allowing the user full use of the application.

As described above, the activation or use of software at a remote device may be controlled. The described control techniques allow for, for example, the number of active users of a software application to be counted, appropriate license agreements to be presented, or software applications to be authenticated and activated. The techniques also simplify the process for activating an application via easy-to-use interfaces, such as menu/display driven interfaces.

### CONCLUSION

An activation and reporting mechanism is described herein that allows application software for mobile terminals to be activated. The activation process may be customized by the application developer using an API provided by the mobile terminal manufacturer. Advantageously, from the standpoint of the application developer, the activation/reporting process can be customized based on a marketing theme or other desires of the application developer.

The foregoing description of the embodiments of the invention provides illustration and description, but is not intended to be exhaustive or to limit the invention to the precise form disclosed. Modifications and variations are possible in light of the above teachings or may be acquired from practice of the invention.

Further, while series of acts have been described with respect to FIGS. 4 and 7-9, the order of the acts may be varied in other implementations consistent with the invention. Moreover, non-dependent acts may be performed in parallel.

It will also be apparent to one of ordinary skill in the art that aspects of the invention, as described above, may be implemented in cellular communication devices/systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A mobile terminal, comprising:
a memory including a software application for use at the mobile terminal; and
logic configured to:
receive an indication that an end-user of the mobile terminal is attempting to use the software application;
transmit registration information to a registration entity; and
activate the software application for use by the end-user.

2. The mobile terminal of claim 1, wherein the registration information includes an identification of the software application being activated and is used to count the number of activations relating to the software application.

3. The mobile terminal of claim 1, wherein the logic is further configured to:
gather the registration information from the end-user.

4. The mobile terminal of claim 1, wherein the registration entity includes one or more of a manufacturer of the mobile terminal, an application provider that authored the software, or a service provider for the mobile terminal.

5. The mobile terminal of claim 3, wherein the registration information includes one or more of a name, address, or a telephone number of the mobile terminal.

6. The mobile terminal of claim 3, wherein the registration information includes a unique identification number of the mobile terminal or an account number of the user associated with the mobile terminal.

7. The mobile terminal of claim 3, wherein the registration information includes payment information for the software application.

8. The mobile terminal of claim 1, wherein transmitting the registration information includes transmitting the registration information as an email message or an SMS message.

9. The mobile terminal of claim 1, further comprising:
receiving a license key at the mobile terminal in response to the transmitting the registration information.

10. The mobile terminal of claim 9, wherein activating the software application for use by the end-user is performed using the license key.

11. The mobile terminal of claim 1, wherein the software application is stored in the memory of the mobile terminal during manufacture of the mobile terminal.

12. The mobile terminal of claim 1, wherein the software application is downloaded to the memory of the mobile terminal.

13. A method for activating software in a mobile terminal, the method comprising:
receiving an indication that an end-user of the mobile terminal is attempting to use the software;
gathering information from the end-user for registering the software;
transmitting the registration information using the mobile terminal to one or more of a manufacturer of the mobile terminal, an application provider associated with the software, or a service provider for the mobile terminal; and
activating the software for use by the end-user.

14. The method of claim 13, wherein the registration information includes one or more of a name, address, a telephone number of the mobile terminal, a unique identification number of the mobile terminal, or an account number of the user associated with a chip installed in the mobile terminal.

15. The method of claim 13, wherein the registration information includes payment information for the software.

16. The method of claim 13, wherein transmitting the registration information includes transmitting the registration information as an email message or an SMS message.

17. The method of claim 13, further comprising:
receiving a license key at the mobile terminal in response to the transmitting the registration information.

18. The method of claim 17, wherein activating the software for use by the end-user is performed using the license key.

19. A method of activating software in a mobile terminal comprising:
determining location information or language preference information for an end-user of the mobile terminal;
selecting a software license agreement based on the determined information;
presenting the selected software license agreement to the end-user; and
activating the software when the end-user accepts the presented software license agreement.

20. The method of claim 19, wherein the location information is automatically determined in response to the end-user attempting to use the software.

21. The method of claim 19, wherein the determined location information includes at least one of a city, zip code, or country of residence.

22. The method of claim 19, further comprising:
receiving an indication from the end-user relating to whether the end-user accepts the software license agreement; and
transmitting the indication to one or more of a manufacturer of the mobile terminal, an application provider that associated with software, or a service provider for the mobile terminal.

23. The method of claim 19, wherein the software is pre-stored in the mobile terminal.

24. The method of claim 19, wherein the software is downloaded to the mobile terminal by an end-user.

25. A device comprising:
means for determining location information for an end-user of a mobile terminal;
means for selecting a software license agreement based on the location information;
means for presenting the selected software license agreement to an end-user of the device; and
means for activating the software when the end-user accepts the presented software license agreement.

26. A mobile device comprising:
a memory storing a software application that requires activation before an end-user is provided with full use privileges for the software application, the activation being performed via an activation process, performed using an interface specified by a designer of the software application, using an application programming interface (API) provided by a manufacturer of the mobile terminal; and
logic configured to provide wireless communication to an end-user of the mobile device, the activation process including communicating with a registration entity via the logic.

27. The mobile device of claim 26, wherein the registration entity includes one or more of a manufacturer of the mobile terminal, an application provider that authored the software application, or a service provider for the mobile device.

28. The mobile device of claim 26, wherein the logic is configured to transmit an email message or an SMS message to activate the software application.
